(19) United States
(12) Patent Application Publication
(10) Pub. No.: US 2019/0188257 A1
(43) Pub. Date: Jun. 20, 2019

(54) CONTEXT ANALYSIS APPARATUS AND COMPUTER PROGRAM THEREFOR

(71) Applicant: National Institute of Information and Communications Technology, Tokyo (JP)

(72) Inventors: Ryu IIDA, Tokyo (JP); Kentaro TORISAWA, Tokyo (JP); Canasai KRUENGKRAI, Tokyo (JP); Jonghoon OH, Tokyo (JP); Julien KLOETZER, Tokyo (JP)

(21) Appl. No.: 16/329,371

(22) PCT Filed: Aug. 30, 2017
(86) PCT No.: PCT/JP2017/031250

§ 371 Date: Feb. 28, 2019

(30) Foreign Application Priority Data
Sep. 5, 2016 (JP) 2016-173017

(51) Int. Cl. G06F 17/27; G06F 16/33; G06N 3/08

(52) U.S. Cl. CPC G06F 17/2765; G06N 3/08; G06F 16/3344; G06F 16/3347

(57) ABSTRACT

A context analysis apparatus includes an analysis control unit for detecting a predicate of which subject is omitted and antecedent candidates thereof, and an anaphora/ellipsis analysis unit determining a word to be identified. The anaphora/ellipsis analysis unit includes: word vector generating units generating a plurality of different types of word vectors from sentences for the antecedent candidates; a convolutional neural network receiving as an input a word vector and trained to output a score indicating the probability of each antecedent candidate being the omitted word; and a list storage unit and a identification unit determining a antecedent candidate having the highest score. The word vectors include a plurality of word vectors each extracted at least by using the object of analysis and character sequences of the entire sentences other than the candidates. Similar processing is also possible on other words such as a referring expression.

### TECHNICAL FIELD

The present invention relates to a context analysis apparatus for identifying, based on a context, a word that has a specific relation with another word in a sentence but cannot be definitely determined from a word sequence in the sentence. More specifically, the present invention relates to a context analysis apparatus for performing an anaphora resolution for identifying a word referred to by a referring expression in a sentence, or an ellipsis resolution for identifying omitted arguments (e.g., an omitted subject) of a predicate in a sentence.

### BACKGROUND ART

In a natural language sentence, arguments of predicates are frequently omitted and referring expressions are frequently used. Let us take an example of sentence 30 in FIG. 1. Example sentence 30 consists of first and second sentences. The second sentence includes a referring expression (pronoun) 42 ┌ [symbol] ┐ (it). Computers cannot determine which word is referred to by referring expression 42 from the word sequence of the sentence. Here, referring expression 42 ┌ [symbol] ┐ refers to expression 40 ┌ [symbol] ┐ (date of new year in MON calendar) in the first sentence. Such a process of identifying the word to which the referring expression refers is called “anaphora resolution.”

On the other hand, see another example of sentence 60 in FIG. 2. This example sentence 60 consists of the first and second sentences. In the second sentence, the subject of a predicate ┌ [symbol] ┐ (have self-diagnosis function) is omitted. Here, at the portion 76 the words 72 ┌ [symbol] ┐ (new exchangers) in the first sentence is omitted. Likewise, the subject of a predicate ┌200 [symbol] [symbol] ┐ (intends to install 200 systems) is omitted. At the portion 74, the word 70 ┌ [symbol] ┐ (Company N) in the first sentence is omitted. Detecting omitted expressions and identifying their antecedent is called “ellipsis resolution.” In the following, the anaphora resolution and ellipsis resolution will be collectively referred to as “anaphora/ellipsis resolution.”

It is relatively easy for a human to identify words that are referred to by referring expressions and zero-pronouns. Such identification is believed to make use of information of contexts surrounding such words. Actually, while a large number of referring expressions and zero-pronouns are used in Japanese, they do not pose any serious problems for human determination.

By contrast, in the field of so-called artificial intelligence, natural language processing is indispensable for realizing communication with humans. Machine translation and question-answering are major problems in natural language processing. The technique of anaphora/ellipsis resolution is an element technology essential to such machine translation and question-answering.

The anaphora/ellipsis resolution, however, has not yet developed to a technical level sufficiently high to be used practically. The main reason is as follows: conventional anaphora/ellipsis resolution techniques mainly use clues obtained from an anaphor (pronouns, zero-pronouns, etc.) and its candidate antecedent, whereas it is difficult to identify a (zero-)anaphoric relation only from such features.

By way of example, in an anaphora/ellipsis resolution algorithm in accordance with Non-Patent Literature 1 listed below, in addition to relatively surface clues such as the results of morphological analysis/syntactic analysis, semantic compatibility between a predicate having a (zero-)pronoun and a candidate antecedent is used as a clue. For example, when an object of a ┌ [symbol] ┐ (eat) is omitted, we identify the antecedent of the omitted object by matching the verb with the entries in a prepared dictionary. As an alternative way, we extract objects of ┌ [symbol] ┐ (eat) from a large-scale document data, and use them as features for machine learning.

Regarding other contextual features, in relation to the anaphora/ellipsis resolution, use of functional words and the like appearing in paths in the dependency structures between antecedent candidates and referring entities (pronoun, zero-pronoun, etc.) (Non-Patent Literature 1) and extraction and use of a partial structure effective for analysis from paths of dependency structures (Non-Patent Literature 2) have been tried.

These pieces of conventional art will be described taking a sentence 90 in FIG. 3 as an example. Sentence 90 shown in FIG. 3 includes predicates 100, 102 and 104. Of these, the subject of predicate 102 (┌ [symbol] ┐ (suffered)) is omitted as represented by zero-pronoun 106. Word candidates for filling the position of zero-pronoun 106 include words 110, 112, 114 and 116 in sentence 90. Of these, the word 112 (┌ [symbol] [symbol] ┐ (government)) is the word that should be filled to the position of zero-pronoun 106. The problem is how to identify this word in natural language processing. Typically, a discriminator trained by machine learning is used for inference of this word.

Referring to FIG. 4, in Non-Patent Literature 1, functional words/symbols in dependency paths between a predicate and word candidates to be identified as an antecedent of an omitted subject are used as contextual features. For this purpose, conventionally, morphological analysis and syntactic analysis/parsing are performed on an input sentence. By way of example, consider a dependency path between ┌ [symbol] [symbol] ┐ (government) and zero-pronoun (represented by “ϕ”). According to Non-Patent Literature 1, discrimination is realized by machine learning utilizing functional words including ┌ [symbol] ┐, ┌ [symbol] ┐, ┌ [symbol] ┐, ┌ [symbol] ┐, ┌ [symbol] ┐, ┌ [symbol] ┐, and ┌ [symbol] ┐ as features.

On the other hand, in Non-Patent Literature 2, a partial tree contributing to classification is obtained from partial structure of a sentence extracted beforehand, and dependency paths thereof are partially abstracted and used for extracting features. For instance, as is shown in FIG. 5, a piece of information that the partial tree of “<noun> [symbol] ”→“<verb>” is effective for ellipsis resolution is obtained beforehand.

There is another method of using contextual features in which a problem of recognizing a shared subject, that is, a problem to find whether two predicates share a subject, and information obtained by solving the problem is used (Non-Patent Literature 3). According to this method, the subject is propagated through the set of predicates that share the subject, thereby realizing a process of ellipsis resolution. In this method, relations between predicates are used as contextual features.

As described above, it would be difficult to improve the performance of the anaphora/ellipsis resolution unless we utilize as clues contexts where referring and referred entities appear.

### CITATION LIST

### Non Patent Literature

NPL 1: Ryu Iida, Massimo Poesio. A Cross-Lingual ILP Solution to Zero Anaphora Resolution. The 49th Annual Meeting of the Association for Computational Linguistics: Human Language Technologies (ACL-HLT2011), pp. 804-813.2011.
NPL2: Ryu Iida, Kentaro Inui, Yuji Matsumoto. Exploiting Syntactic Patterns as Clues in Zero-Anaphora Resolution. 21st International Conference on Computational Linguistics and 44th Annual Meeting of the Association for Computational Linguistics (COLING/ACL), pp. 625-632. 2006.
NPL3: Ryu Iida, Kentaro Torisawa, Chikara Hashimoto, Jong-Hoon Oh, Julien Kloetzer. Intra-sentential Zero Anaphora Resolution using Subject Sharing Recognition. In Proceedings of the 2015 Conference on Empirical Methods in Natural Language Processing, pp. 2179-2189, 2015.
NPL4: Hiroki Ouchi, Hiroyuki Shindo, Kevin Duh, and Yuji Matsumoto. 2015. Joint case argument identification for Japanese predicate argument structure analysis. In Proceedings of the 53rd Annual Meeting of the Association for Computational Linguistics and the 7th International Joint Conference on Natural Language Processing, pages 961-970.
NPL5: Ilya Sutskever, Oriol Vinyals, Quoc Le, Sequence to Sequence Learning with Neural Networks, NIPS 2014.

### SUMMARY OF INVENTION

### Technical Problem

As described above, one reason why anaphora/ellipsis resolution performances are not improved is that the method of using context information has much room for improvement. When contextual information is used in an existing analysis technique, contextual features to be used are sorted out beforehand by reflection of researchers. There is an undeniable possibility in this method that important information represented by contexts is overlooked. In order to solve this problem, it is necessary to take measures to prevent important information from being overlooked or discarded. We could not find awareness of such a problem in past studies, and it has been unclear what approach is to be taken to make full use of contextual information.

Therefore, an object of the present invention is to provide a context analysis apparatus enabling highly accurate sentence analysis such as the anaphora/ellipsis resolution by comprehensively and efficiently using contextual features.

### Solution to Problem

According to a first aspect, the present invention provides a context analysis apparatus, for identifying, in a context of sentences containing a first word and a second word having a prescribed relation with the first word, wherein the relation of the second word with the first word is not clearly recognizable only from the sentences. The context analysis apparatus includes: an analysis object detecting means for detecting the first word as an object of analysis in the sentences; a candidate searching means for searching, in the sentences, word candidates that have a possibility of being the second word having a certain relation with the object of analysis, for the object of analysis detected by the analysis object detecting means; and a word determining means for determining a one word candidate from the word candidates searched out by the candidate searching means as the second word, for the object of analysis detected by the analysis object detecting means. The word determining means includes: a word vector group generating means for generating a group of different types of word vectors determined by the sentences, the object of analysis and the word candidate, for each of the word candidates; a score calculating means pretrained by machine learning for outputting, for each of the word candidates, a score indicating a possibility that the word candidate is related to the object of analysis, using the group of word vectors generated by the word vector group generating means as inputs; and a word identifying means for identifying a word candidate having the best score output from the score calculating means as the word having a certain relation with the object of analysis. The group of different types of word vectors each includes one or a plurality of word vectors generated by using at least a word sequence of entire sentences other than the object of analysis and the word candidate.

Preferably, the score calculating means is a neural network having a plurality of sub-networks; and the plurality of word vectors is each input to the plurality of sub-networks included in the neural network.

More preferably, the word vector group generating means includes any combination of: a first generating means for generating a word vector sequence representing a word sequence included in entire sentences; a second generating means for generating a word vector sequence respectively from a plurality of word sequences divided by the first word and the word candidates in the sentence; a third generating means for generating and outputting, based on a dependency tree obtained by parsing the sentences, arbitrary combinations of word vectors obtained from word sequences obtained from a partial tree related to the word candidates, word sequences obtained from a dependent partial tree of the first word, word sequences obtained from a dependency path of the dependency tree between the word candidates and the first word, and word sequences obtained from each of the remaining partial trees of the dependency tree; and a fourth generating means for generating and outputting two word vectors representing word sequences obtained respectively from word sequences preceding and succeeding the first word in the sentences.

Each of the plurality of sub-networks is a convolutional neural network. Alternatively, each of the plurality of sub-networks may be a LSTM (Long Short Term Memory).

More preferably, the neural network includes a multi-column convolutional neural network (MCNN), and the convolutional neural network included in each column of the multi-column convolutional neural network is so connected as to receive mutually different word vectors from the word vector group generating means.

Sub-networks forming the MCNN may have the same parameters.

According to a second aspect, the present invention provides a computer program causing a computer to function as every means of any of the context analysis apparatuses described above.

### BRIEF DESCRIPTION OF DRAWINGS

FIG. 1 is a schematic illustration showing anaphora resolution.

FIG. 2 is a schematic illustration showing ellipsis resolution.

FIG. 3 is a schematic illustration showing an example of use of contextual features.

FIG. 4 is a schematic illustration showing a conventional technique disclosed in Non-Patent Literature 1.

FIG. 5 is a schematic illustration showing a conventional technique disclosed in Non-Patent Literature 2.

FIG. 6 is a block diagram showing a configuration of the anaphora/ellipsis resolution system based on the multi-column convolutional neural network (MCNN) in accordance with a first embodiment of the present invention.

FIG. 7 is a schematic illustration showing a SurfSeq vector used in the system shown in FIG. 6.

FIG. 8 is a schematic illustration showing a DepTree vector used in the system shown in FIG. 6.

FIG. 9 is a schematic illustration showing a Predtext vector used in the system shown in FIG. 6.

FIG. 10 is a block diagram showing a schematic configuration of an MCNN used in the system in FIG. 6.

FIG. 11 is a schematic illustration showing a function of MCNN in FIG. 10.

FIG. 12 is a flowchart representing a control structure of a program realizing the anaphora/ellipsis resolution unit shown in FIG. 6.

FIG. 13 is a graph showing the effects of the system in accordance with the first embodiment of the present invention.

FIG. 14 is a block diagram showing a configuration of the anaphora/ellipsis resolution system based on the multi-column (MC) LSTM in accordance with a second embodiment of the present invention.

FIG. 15 is a schematic illustration showing the antecedent identification of zero-pronoun in accordance with the second embodiment.

FIG. 16 shows an appearance of a computer executing a program for realizing the system shown in FIG. 6.

FIG. 17 is a hardware block diagram of the computer of which appearance is shown in FIG. 16.

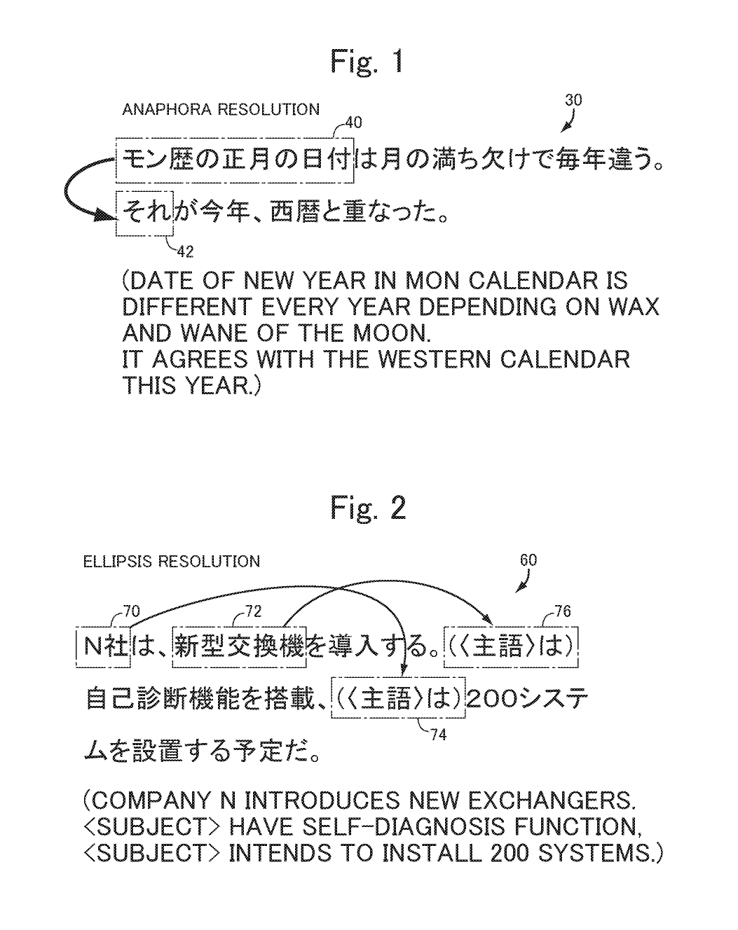

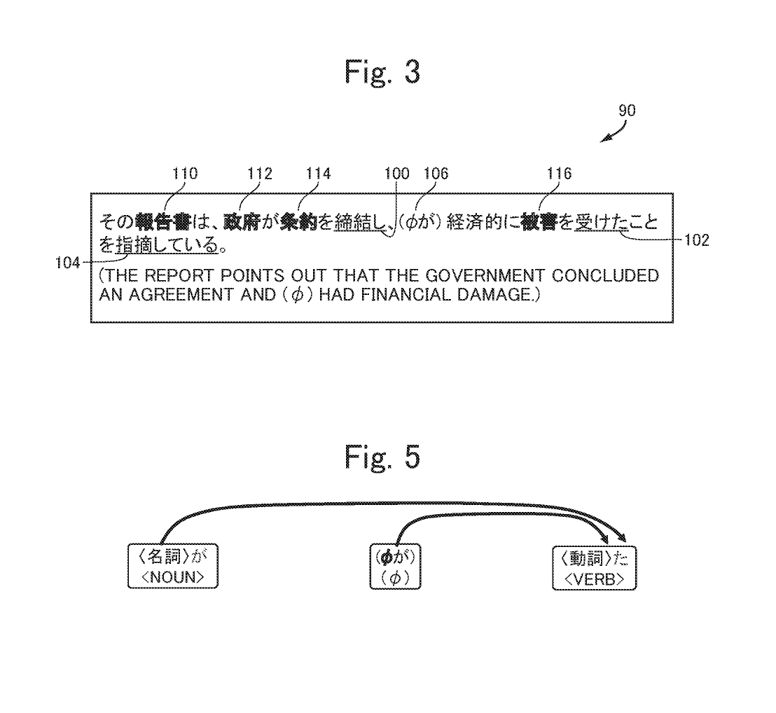

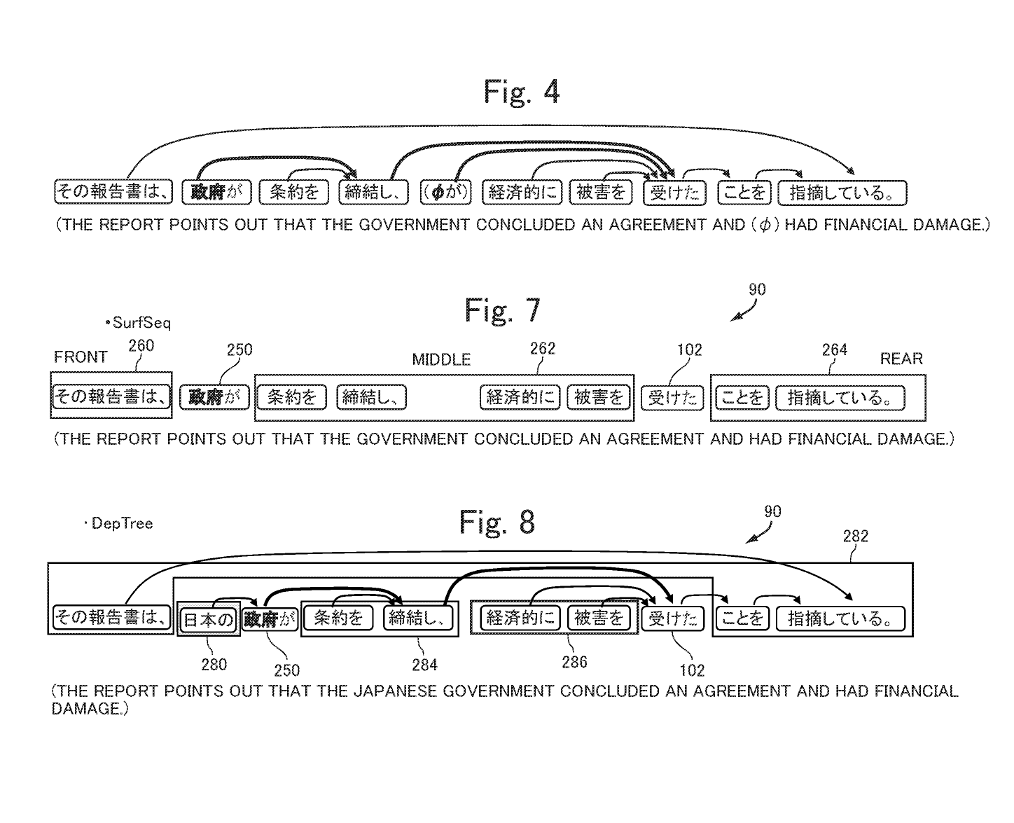

### DESCRIPTION OF EMBODIMENTS

In the following description and in the drawings, the same components are denoted by the same reference characters. Therefore, detailed description thereof will not be repeated.

### First Embodiment

<Overall Configuration>

Referring to FIG. 6, an overall configuration of an anaphora/ellipsis resolution system 160 in accordance with an embodiment of the present invention will be described first.

Anaphora/ellipsis resolution system 160 includes: a morphological analysis unit 200 performing morphological analysis of a received input sentence 170; a dependency relation analysis unit 202 performing dependency relation analysis of a sequence of morphemes output from morphological analysis unit 200 and outputting an analyzed sentence 204 having information of dependency relation added; an analysis control unit 230 controlling various units as described below, for detecting, from the analyzed sentence 204, a referring expression and a predicate of which subject is omitted as objects of context analysis, searching for antecedent candidates of the referring expression and candidates (antecedent candidates of zero-pronouns) of words that are filled to the position of a zero-pronoun and performing a process for determining a single antecedent of each referring expression and a single antecedent of each zero-pronoun for each of the combinations of these candidates; an MCNN 214 pretrained to determine an antecedent candidate of each referring expression and an antecedent candidate of each zero-pronoun; and a anaphora/ellipsis analysis unit 216 controlled by analysis control unit 230, for performing anaphora/ellipsis resolution of analyzed sentence 204 with reference to MCNN 214, adding to the referring expression a piece of information representing the word that is referred to thereby, and adding to a zero-pronoun a piece of information identifying a word to be filled, and providing the result as an output sentence 174.

Anaphora/ellipsis analysis unit 216 includes: a Base word sequence extracting unit 206, a SurfSeq word sequence extracting unit 208, a DepTree word sequence extracting unit 210 and a PredContext word sequence extracting unit 212, connected to receive a combination of a referring expression and its antecedent candidate, or a combination of a predicate of which subject is omitted and its antecedent candidate for the subject, respectively, from analysis control unit 230, and for extracting a word sequence for generating a Base vector sequence, a SurfSeq vector sequence, a DepTree vector sequence and a PredContext vector sequence from a sentence, as will be described later; a word vector converting unit 238 connected to receive a Base word sequence, SurfSeq word sequences, DepTree word sequences and PredContext word sequences from Base word sequence extracting unit 206, SurfSeq word sequence extracting unit 208, DepTree word sequence extracting unit 210 and PredContext word sequence extracting unit 212, respectively, and for converting these word sequences to word vector (Word Embedding Vector) sequences; a score calculating unit 232 calculating and outputting a score of each of the antecedent candidates or the antecedent candidates of the combinations given from analysis control unit 230, based on the word sequences output from word vector converting unit 238 using MCNN 214; a list storage unit 234 connected to store the scores output from score calculating unit 232 for each referring expression and each zero-pronoun as a list of antecedent candidates of each referring expression or each zero-pronoun; and an identification unit 236 connected to select a candidate having the highest score for each referring expression and each zero-pronoun in the analyzed sentence 204 based on the list stored in list storage unit 234, for identifying an antecedent of a referring expression or a zero-pronoun by selecting the candidate that has the highest score and for outputting the sentence in which all antecedents of zero-pronouns are filled as the output sentence 174.

Each of the Base word sequence extracted by Base word sequence extracting unit 206, the SurfSeq word sequences extracted by SurfSeq word sequence extracting unit 208, the DepTree word sequences extracted by DepTree word sequence extracting unit 210 and the PredContext word sequences extracted by PredContext word sequence extracting unit 212 is extracted from the whole sentence.

Base word sequence extracting unit 206 extracts a word sequence from a pair of a noun as an object of ellipsis resolution and a predicate possibly having a zero-pronoun included in analyzed sentence 204, and outputs it as a Base word sequence. Vector converting unit 238 generates a Base vector sequence as a word vector sequence, from the word sequence. In the present embodiment, in order to maintain the order of appearance of words and to reduce amount of computation, Word Embedding Vectors are used as all the word vectors as will be discussed in the following.

For easier understanding, the following will describe a method of generating a set of word vector sequences as candidates of a subject of a predicate of which the subject is omitted.

Referring to FIG. 7, word sequences extracted by SurfSeq word sequence extracting unit 208 shown in FIG. 6 include, based on the order of appearance of word sequences in a sentence 90, a word sequence 260 from the beginning of the sentence to an antecedent candidate 250, a word sequence 262 between antecedent candidate 250 and a predicate 102, and a word sequence 264 from predicate 102 to the end of the sentence. Therefore, the SurfSeq vector sequence is obtained as three Word Embedding Vectors.

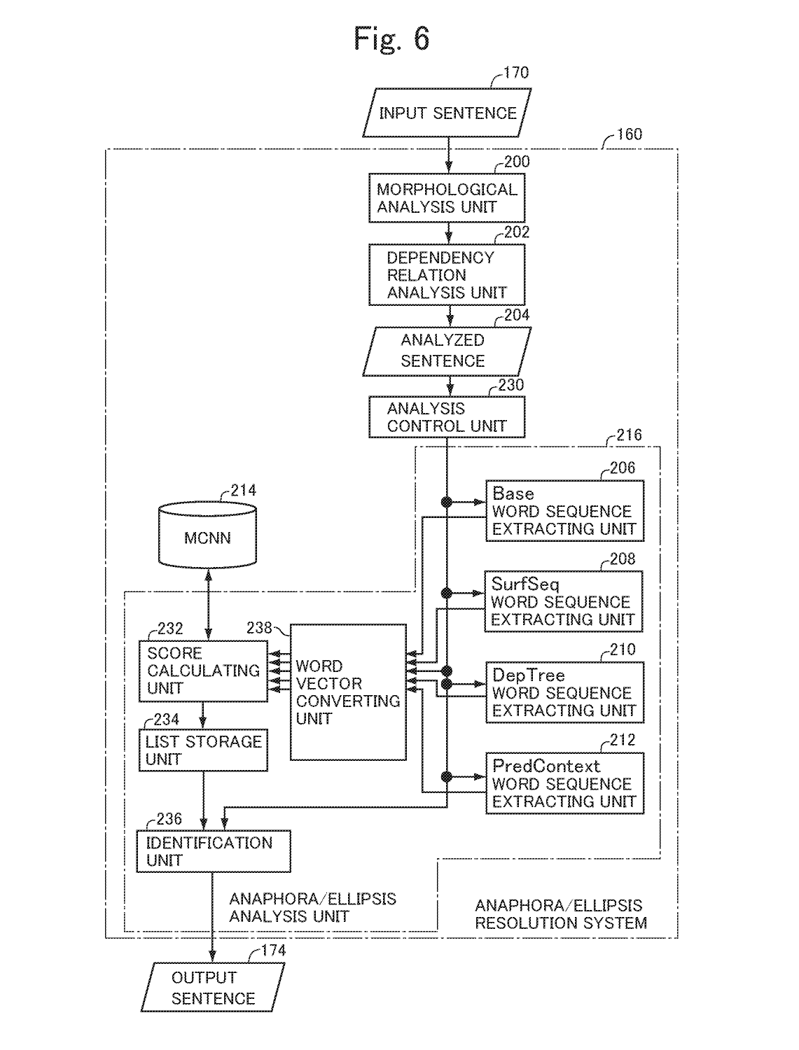

Referring to FIG. 8, word sequences extracted by DepTree word sequence extracting unit 210 include, based on a dependency tree of sentence 90, word sequences obtained respectively from a partial tree 280 related to antecedent candidate 250, a partial tree 282 as a dependent of predicate 102, a dependency path 284 between antecedent candidate and predicate 102, and others 286. Therefore, in this example, the DepTree vector sequence is obtained as four Word Embedding Vectors.

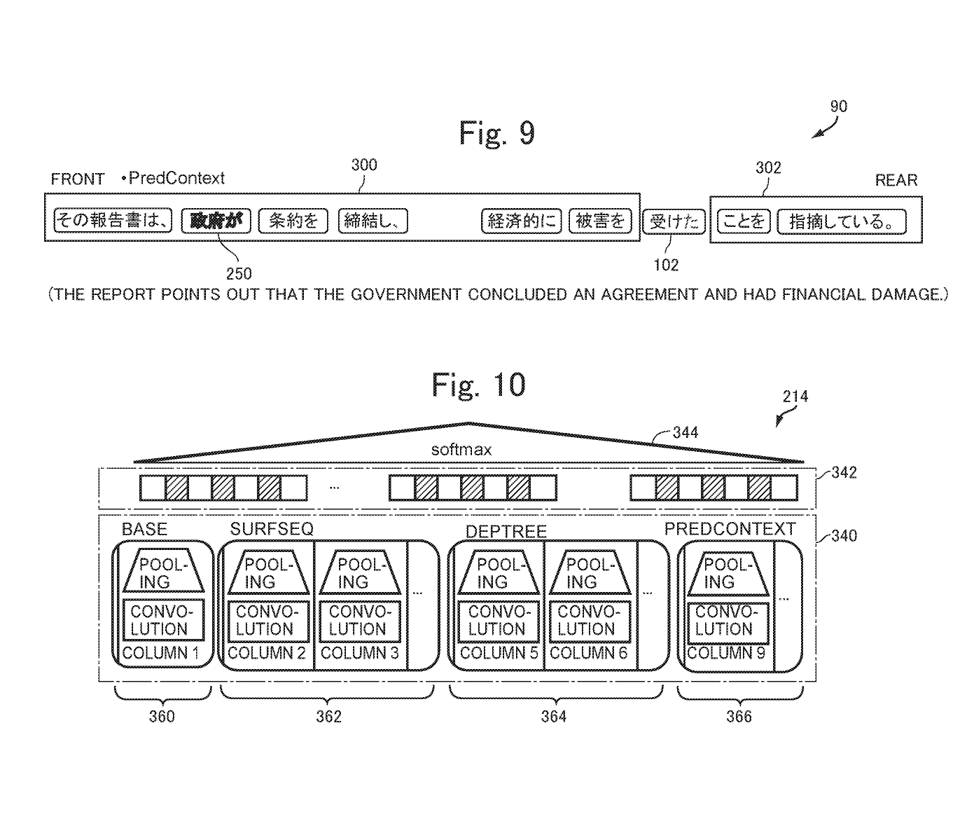

Referring to FIG. 9, word sequences extracted by PredContext word sequence extracting unit 212 include, in sentence 90, a word sequence 300 preceding and a word sequence 302 succeeding a predicate 102. Therefore, in this example, the PredContext word sequence is obtained as two Word Embedding Vectors.

Referring to FIG. 10, in the present embodiment, MCNN 214 includes a neural network layer 340 consisting of first to fourth convolutional neural network groups 360, 362, 364 and 366; a concatenating layer 342 connected to linearly concatenate outputs of respective neural networks in neural network layer 340; and a Softmax layer 344 connected to apply Softmax function to a vector output from concatenating layer 342 for evaluating whether an antecedent candidate is a proper antecedent by the score between 0 to 1 and outputting the evaluation result.

Neural network layer 340 includes, as described above, the first convolutional neural network group 360, the second convolutional neural network group 362, the third convolutional neural network group 364 and the fourth convolutional neural network group 366.

The first convolutional neural network group 360 includes a first column of sub-network receiving the Base vector. The second convolutional neural network group 362 includes the second, third and fourth columns of sub-networks receiving three SurfSeq vector sequences, respectively. The third convolutional neural network group 364 includes the fifth, sixth, seventh and eighth columns of sub-networks receiving four DepTree vector sequences, respectively. The fourth convolutional neural network group 366 includes the ninth and tenth columns of sub-networks receiving two PredContext vector sequences. These sub-networks are all convolutional neural networks.

Outputs from respective convolutional neural networks of neural network layer 340 are simply concatenated linearly by concatenating layer 342 to be an input vector to Softmax layer 344.

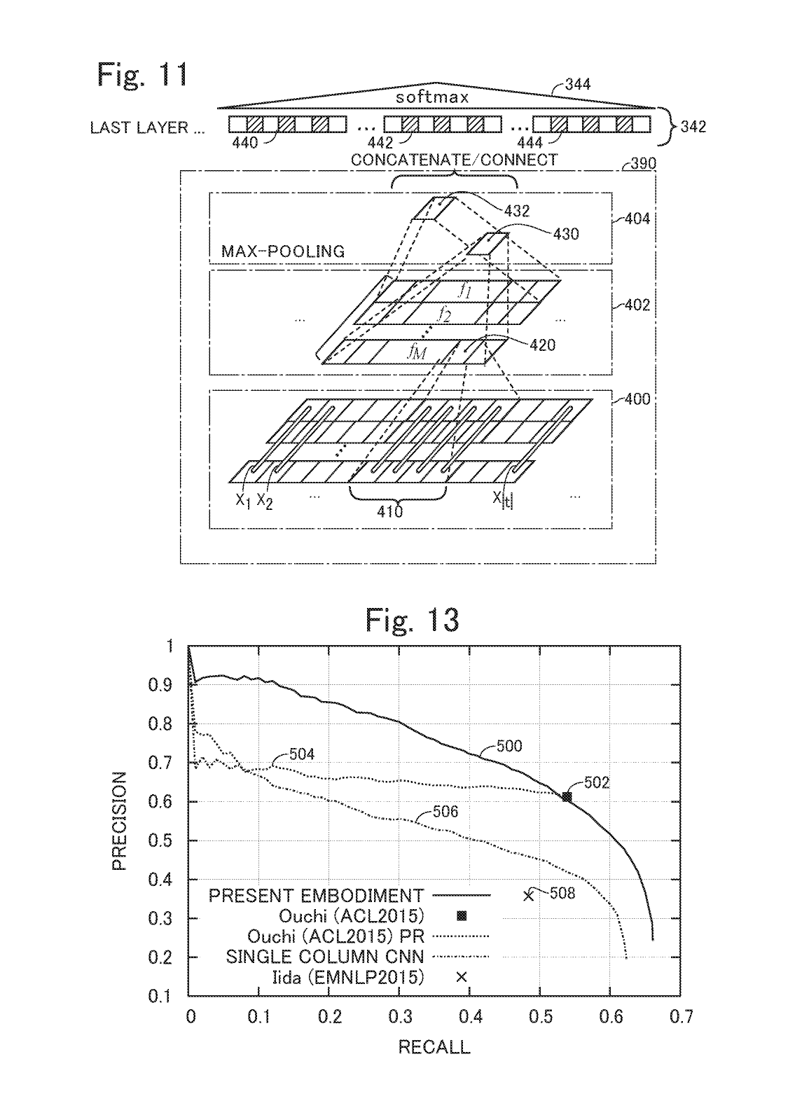

Functions of MCNN 214 will be described in greater detail. FIG. 11 shows, as a representative, a convolutional neural network 390. Here, for easier description, it is assumed that convolutional neural network 390 consists simply of an input layer 400, a convolutional layer 402 and a pooling layer 404, while the network may consist of a plurality of sets of these three layers.

To input layer 400, word vector sequences X₁, X₂, . . . , X_{|t|} output from word vector converting unit 238 are input through score calculating unit 232. The word vector sequences X₁, X₂, . . . , X_{|t|} are represented as a matrix T=[X₁, X₂, . . . , X_{|t|}]^{T}. To the matrix T, M feature maps are applied. The feature map is a vector and a vector O as an element of each feature map is calculated by applying a filter represented by fⱼ (1≤j≤M) to an N-gram comprised of continuous word vectors, while shifting N-gram 410. N is an arbitrary natural number, which is N=3 in this embodiment. Specifically, O is given by the equation below.

O=f(W_{f}_{ⱼ}·x_{i′j:N-1}+bᵢⱼ) (1)

where · represents element-by-element multiplication followed by summation of the results, and f(x)=max (0, x) (normalized linear function). Further, if the number of elements of word vector is d, weight W_{fj} is a real matrix of d×N dimensions, and bias bᵢⱼ is a real number.

It is noted that N may be the same for the entire feature maps or N may be different for some feature maps. Relevant value of N may be 2, 3, 4 and 5. In the present embodiment, all convolutional neural networks have the same weight matrices. Though the weight matrices may be different, the accuracy becomes higher when they are equal in comparison with the accuracy when different weight matrices are trained independently.

For each feature map, the subsequent pooling layer 404 performs so-called max pooling. Specifically, pooling layer 404 selects, from elements of feature map f_{M}, for example, the maximum element 420 and takes it out as an element 430. By performing this process on each of the feature maps, elements 432, . . . , 430 are taken out, and these are concatenated in the order of f₁ to f_{M} and output as a vector 442 to concatenating layer 342. Vectors 440, . . . , 442, . . . , 444 obtained in this manner from respective convolutional neural networks are output to concatenating layer 342. Concatenating layer 342 simply concatenates vectors 440, . . . , 442, . . . , 444 linearly and applies the result to Softmax layer 344. Regarding pooling layer 404, one that performs max pooling is said to have a higher accuracy than one that adopts mean value. It is possible, however, to adopt a mean value, or other representative value may be used if that well represents characteristics of the lower layer.

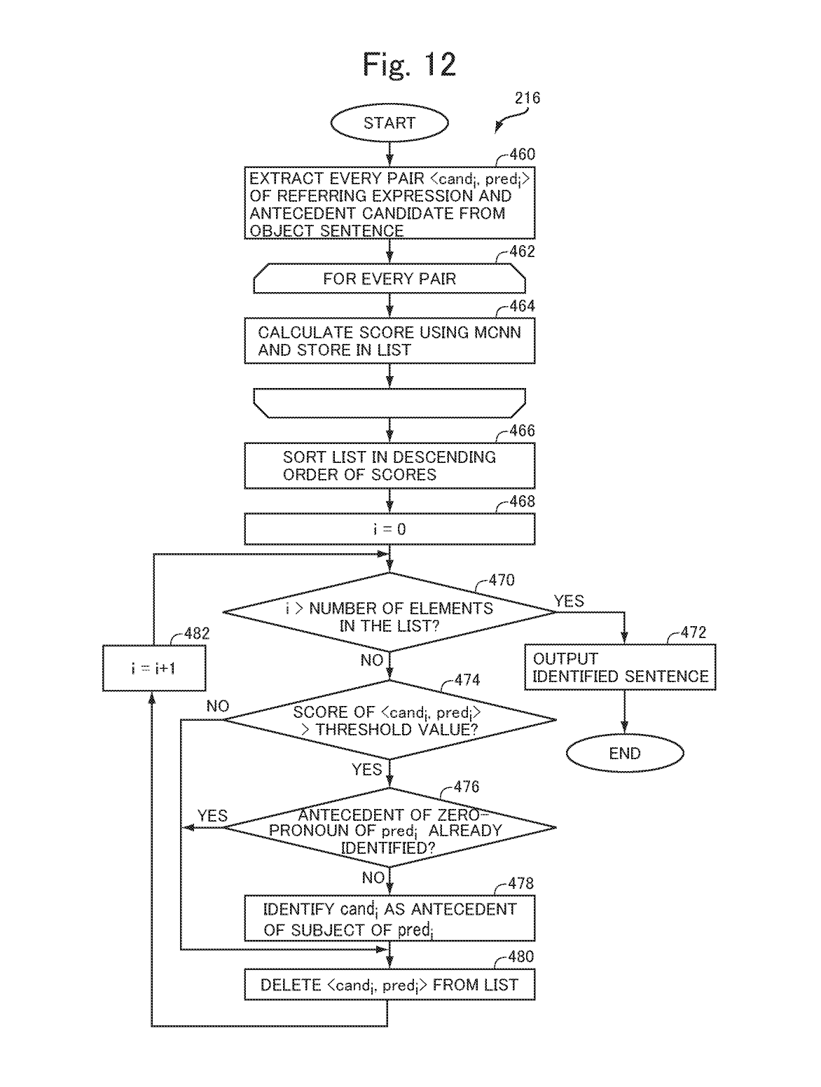

Anaphora/ellipsis analysis unit 216 shown in FIG. 6 will be described. Anaphora/ellipsis analysis unit 216 is realized by computer hardware including a memory and a processor, and computer software executed thereon. FIG. 12 shows, in the form of a flowchart, the control structure of such a computer program.

Referring to FIG. 12, this program includes: a step 460 of generating every pair <candᵢ;predᵢ> of a referring expression or a predicate predᵢ having its subject omitted and an antecedent candidate candᵢ thereof from a sentence as an object of resolution; a step 462 of executing, on every pair, a step 464 of calculating a score of a pair generated at step 460 using MCNN 214 and storing the score in the form of a list in the memory; and a step 466 of sorting the list calculated at step 462 in a descending order of score n. Here, the pair <candᵢ;predᵢ> represents every possible combination of a predicate and a word possible as an antecedent candidate of the predicate. Specifically, in the set of pairs, each predicate and each antecedent candidate will appear several times.

The program further includes: a step 468 of initializing an iteration control variable i to 0; a step 470 of comparing whether the value of variable i is larger than the number of the elements in the list, and branching the control flow depending on whether the comparison is positive or negative; a step 474 executed if the result of comparison at step 470 is negative, of branching the control flow depending on whether the score of the pair <candᵢ;predᵢ> is larger than a prescribed value; a step 476 executed if the determination at step 474 is positive, of branching the control flow depending on whether an antecedent of a zero-pronoun of predicate predᵢ has already identified; and a step 478, executed if the determination at step 476 is negative, of identifying candᵢ as an antecedent of the omitted subject of predicate predᵢ. The possible range of the threshold value used at step 474 is, for example, about 0.7 to about 0.9.

The program further includes: a step 480, executed if the determination at step 474 is negative, the determination at step 476 is negative or if the process at step 478 is finished, of deleting <candᵢ;predᵢ> from the list; a step 482, following step 480, of adding 1 to the value of variable i and returning the control flow to step 470; and a step 472, executed if the determination at step 470 is positive, of outputting a sentence in which all antecedents of zero-pronouns are filled and ending the process.

Learning of MCNN 214 is the same as the learning of a typical neural network. It is noted, however, that different from the determination in the embodiment described above, ten word vectors mentioned above are used as word vectors in the training data and data indicating whether the combination of a predicate and an antecedent candidate under processing is correct or not is added to training data.

<Operation>

Anaphora/ellipsis resolution system 160 shown in FIGS. 6 to 12 operates as follows. When an input sentence 170 is given to anaphora/ellipsis resolution system 160, morphological analysis unit 200 performs a morphological analysis of input sentence 170 and applies a morpheme sequence to the dependency relation analysis unit 202. Dependency analysis unit 202 performs a dependency relation analysis of the morpheme sequence, and applies an analyzed sentence 204 having dependency information added, to analysis control unit 230.

Analysis control unit 230 searches for every predicate of which the subject is omitted in analyzed sentence 204, searches for an antecedent candidate of each predicate in analyzed sentence 204, and executes the following process on each of their combinations. Specifically, analysis control unit 230 selects one combination of a predicate and an antecedent candidate as an object of processing, and applies it to Base word sequence extracting unit 206, SurfSeq word sequence extracting unit 208, DepTree word sequence extracting unit 210 and PredContext word sequence extracting unit 212. Base word sequence extracting unit 206, SurfSeq word sequence extracting unit 208, DepTree word sequence extracting unit 210 and PredContext word sequence extracting unit 212 extract a Base word sequence, SurfSeq word sequences, DepTree word sequences and PredContext word sequences from analyzed sentence 204, respectively, and outputs them as word sequence groups. These word sequence groups are converted to a word vector sequence by word vector converting unit 238 and given to score calculating unit 232.

When the word vector sequence is output from word vector converting unit 238, analysis control unit 230 causes score calculating unit 232 to execute the following process. Score calculating unit 232 applies the Base vector sequence to the input of one of the sub-networks of the first convolutional neural network group 360 of MCNN 214. Score calculating unit 232 applies three SurfSeq vector sequences respectively to the inputs of three sub-networks of the second convolutional neural network group 362 of MCNN 214. Score calculating unit 232 further applies four DepTree vector sequences to the four sub-networks of the third convolutional neural network group 364, and applies two PredContext vector sequences to the two sub-networks of the fourth convolutional neural network group 366. In response to these input word vectors, MCNN 214 calculates a score corresponding to the probability that the set of predicate and antecedent candidate corresponding to the given word vector group is correct, and applies it to score calculating unit 232. Score calculating unit 232 combines the score with the combination of a predicate and an antecedent candidate, and applies the resulting combination to list storage unit 234. List storage unit 234 stores this combination as an item of the list.

When analysis control unit 230 finishes execution of the process described above on all the combinations of the predicate and the antecedent candidate, list storage unit 234 will have stored a list of all combinations of predicate and antecedent candidate with respective scores (FIG. 12, steps 460, 462, 464).

Identification unit 236 sorts the list stored in list storage unit 234 in a descending order of scores (FIG. 12, step 466). Identification unit 236 reads items from the head of the list, and when processing of every item ends (YES at step 470), the sentence in which all the antecedents of zero-pronouns are filled is output (step 472) and the process ends. If any item remains (NO at step 470), whether the score of the read item is larger than a threshold value or not is determined (step 474). If the score is not larger than the threshold value (NO at step 474), the item is deleted from the list at step 480, and the process proceeds to the next item (step 482 to step 470). If the score is larger than the threshold value (YES at step 474), whether the subject position corresponding to the predicate of the item has been already filled by another antecedent candidate or not is determined at step 476 (step 476). If it has been already filled (YES at step 476), the item is deleted from the list (step 480), and the process proceeds to the next item (step 482 to step 470). If the subject position corresponding to the predicate of the item has not been filled yet (NO at step 476), the zero-pronoun of the subject position corresponding to the predicate is filled by the antecedent candidate of the item at step 478. Further, at step 480, the item is deleted from the list and the process proceeds to the next item (step 482 to step 470).

When all possible identification are completed in this manner, the determination at step 470 becomes YES, and at step 472, the sentence in which all the antecedents of zero-pronouns are filled is output.

As described above, according to the present embodiment, different from the conventional approaches, whether the combination of a predicate and an antecedent candidate (or the combination of a referring expression and an antecedent candidate) is correct or not is identified using all word sequences forming sentence, and using vectors generated from a plurality of different viewpoints. It is now possible to identify from various viewpoints and to improve the accuracy of the anaphora/ellipsis resolution, without necessitating conventionally required manual adjustment of word vectors.

In fact, an experiment confirms that the accuracy of the anaphora/ellipsis resolution in accordance with the concept of the embodiment above becomes higher than that of the conventional approaches. The results are as shown in a graph in FIG. 13. In this experiment, the same corpus as used in Non-Patent Literature 3 was used. In this corpus, the correspondence between predicates and antecedents of the predicates' zero-pronouns are manually annotated in advance. This corpus was divided into five sub-corpora, of which three were used as training data, one as a development set and one as test data. Using the data, the identification process was executed by the anaphora/ellipsis resolution technique in accordance with the above-described embodiment and other three methods for comparison, and the results were compared.

Referring to FIG. 13, graph 500 is a PR curve plotting the result of the experiment in accordance with the embodiment above. In this experiment, the above-described four types of word vectors were all used. Graph 506 is a PR curve of an example obtained by generating word vectors from all words included in sentence, not using a multi-column but a single-column convolutional neural network. A black square 502 and graph 504 represent a PR curve for comparison, obtained from the experiment and a result of the global optimizing method disclosed in Non-Patent Literature 4. According to this method, a development set is unnecessary. Therefore, four sub-corpora including the development set were used for training. While we can obtain relations between the predicates-arguments of subjects, objects and indirect objects by this method, we used outputs related only to subject ellipsis resolution in sentence. As in the case of the examples shown in Non-Patent Literature 4, an average of 10 individual trials is used. Further, result 508 of the method in accordance with Non-Patent Literature 3 is also plotted by x in the graph.

As is apparent from FIG. 13, the method according to the above-described embodiment attained a PR curve better than any other method, and has high precision over a wide range. Therefore, we can assume that the above-described method of selecting word vectors represents context information more appropriately than conventional methods. Further, by the method in accordance with the embodiment above, higher precision was attained than the approach of using a single column neural network. This indicates that the use of MCNN could improve the recall.

### Second Embodiment

### <Configuration>

The anaphora/ellipsis resolution system 160 in accordance with the first embodiment uses MCNN 214 for calculating scores at score calculating unit 232. The present invention, however, is not limited to such an embodiment. A neural network having as a component element a network architecture called LSTM may be used. In the following, an embodiment using LSTM will be described.

LSTM is one type of recurrent neural networks and it has an ability to store an input sequence. While there are variations in actual implementation, it realizes a scheme that learns using multiple sets of training data, each set consisting of an input sequence and a corresponding output sequence, and that provides, receiving an input sequence, a corresponding output sequence. A system for automatically translating English to French using this scheme has already been used (Non-Patent Literature 5).

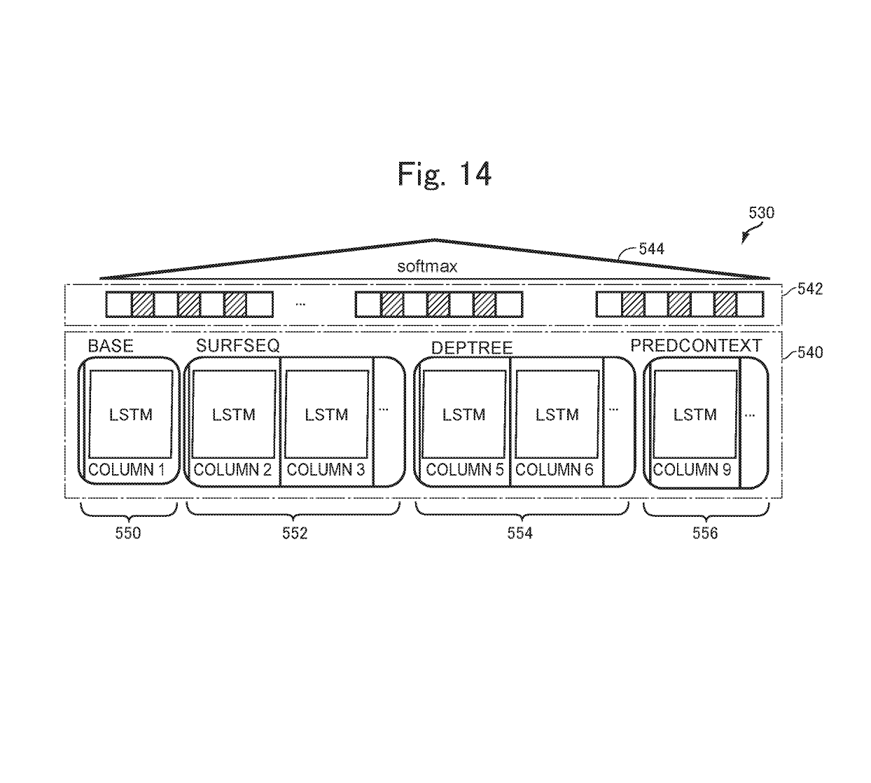

Referring to FIG. 14, MCLSTM (Multi Column LSTM) 530 used in place of MCNN 214 in the present embodiment includes: LSTM layer 540; a concatenating layer 542, similar to concatenating layer 342 of the first embodiment, linearly concatenating outputs of respective LSTMs in LSTM layer 540; and a Softmax layer 544 applying Softmax function to a vector output from concatenating layer 542 and thereby evaluating and outputting a score of 0 to 1 as to whether the antecedent candidate is a proper antecedent.

LSTM layer 540 includes a first LSTM group 550, a second LSTM group 552, a third LSTM group 554 and a fourth LSTM group 556. Each of these includes a sub-network formed of LSTM.

Similar to the first convolutional neural network group 360 of the first embodiment, the first LSTM group 550 includes a first column of LSTM receiving the Base vector sequence. Similar to the second convolutional neural network group 362 of the first embodiment, the second LSTM group 552 includes the second, third and fourth column of LSTMs receiving three SurfSeq vector sequences, respectively. Similar to the third convolutional neural network group 364 of the first embodiment, the third LSTM group 554 includes the fifth, sixth, seventh and eighth columns of LSTMs receiving four DepTree vector sequences, respectively. Similar to the fourth convolutional neural network group 366 of the first embodiment, the fourth LSTM group 556 includes the ninth and tenth columns of LSTMs receiving two PredContext vector sequences.

Outputs from respective LSTMs of LSTM layer 540 are simply concatenated linearly by concatenating layer 542 to be an input vector to Softmax layer 544.

It is noted, however, that in the present embodiment, each word vector sequence is generated in a form of a vector sequence consisting of word vectors generated word by word in accordance with the order of appearance. The word vectors forming these vector sequences are successively applied to corresponding LSTMs in accordance with the order of appearance of the respective words.

As in the first embodiment, the learning of the LSTM groups forming LSTM layer 540 is conducted by back propagation using training data of MCLSTM 530 as a whole. This learning is such that when a vector sequence is applied, MCLSTM 530 outputs a probability that a word that is an antecedent candidate is a proper antecedent.

<Operation>

The operation of the anaphora/ellipsis resolution system in accordance with the second embodiment is basically the same as that of the anaphora/ellipsis resolution system 160 of the first embodiment. Inputs to vector sequences of respective LSTMs forming LSTM layer 540 are also the same as in the first embodiment.

The process is similar to that of the first embodiment, as can be seen from the outline shown in FIG. 12. What is different is that at step 464 in FIG. 12, MCLSTM 530 shown in FIG. 14 is used in place of MCNN 214 (FIG. 10) of the first embodiment, and those vector sequences consisting of word vectors are used as word vector sequences, with each word vector being input successively to MCLSTM 530.

In the present embodiment, every time each word vector of the vector sequences is input to each LSTM forming LSTM layer 540, each LSTM changes its inner state, and its output changes. The outputs of respective LSTMs when the input of the vector sequences is completed are determined in accordance with the vector sequences that have been input by that time. Concatenating layer 542 concatenates these outputs, thereby providing an input to Softmax layer 544. Softmax layer 544 outputs a result of softmax function on this input. This value is a probability that an antecedent candidate of a referring expression or a predicate of which subject is omitted when the vector sequence was formed is a proper antecedent, as described above. If this probability calculated for a certain antecedent candidate is larger than probabilities calculated for other antecedent candidates and is larger than a threshold value θ, the antecedent candidate is inferred to be proper antecedent.

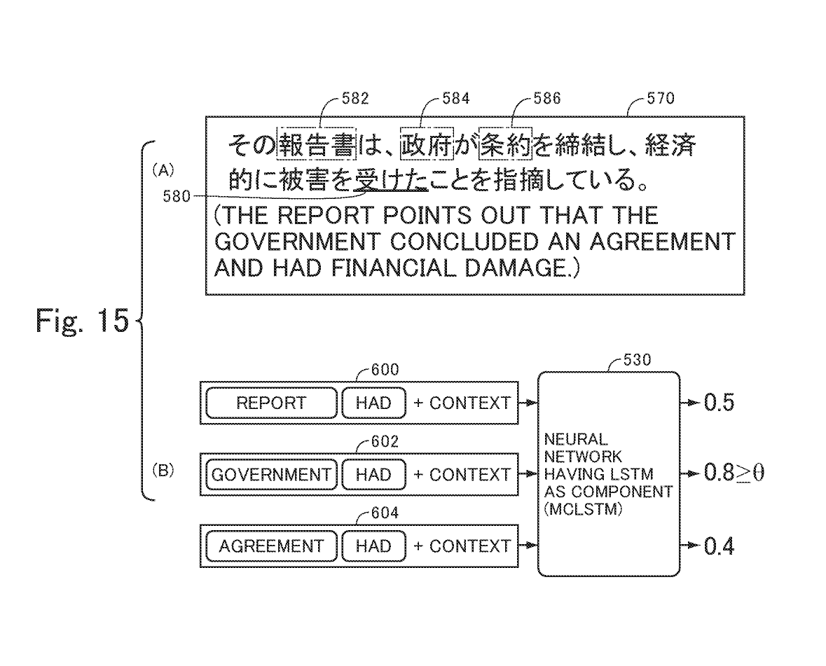

Referring to FIG. 15(A), assume that in sentence 570, a subject for an expression 580 ┌ [symbol] ┐ “received” as a predicate is unknown, and that words ┌ [symbol] [symbol] ┐ “report” 582, ┌ [symbol] ┐ “government” 584 and ┌ [symbol] ┐ “treaty” 586 are detected as antecedent candidates.

As shown in FIG. 15(B), for words 582, 584 and 586, vector sequences 600, 602 and 604 respectively representing word vectors are obtained. These are given as inputs to MCLSTM 530. Assume that as a result, values of 0.5, 0.8 and 0.4 are obtained as outputs of MCLSTM 530 for vector sequences 600, 602 and 604, respectively. Among these, 0.8 is the largest. If the value 0.8 is larger than the threshold value θ, then the word 584 corresponding to the vector sequence 602, that is, the word ┌ [symbol] ┐ “government” is considered to be the subject of ┌ [symbol] ┐ “received.”

As shown in FIG. 12, such a process is executed on every pair of a referring expression or a predicate of which subject is omitted and its antecedent candidate in the sentence as a target, and thus, the target sentence is analyzed.

[Computer Implementation]

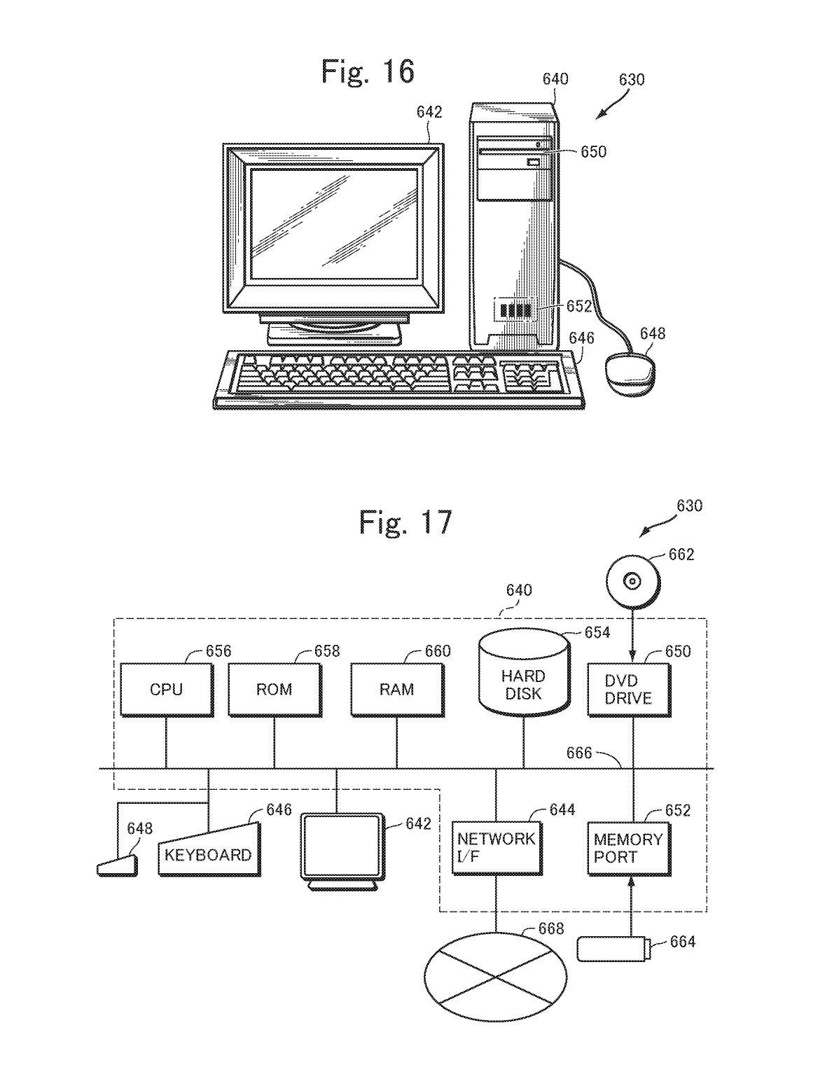

The anaphora/ellipsis resolution systems in accordance with the first and second embodiments above can be implemented by computer hardware and computer programs executed on the computer hardware. FIG. 16 shows an appearance of computer system 630 and FIG. 17 shows an internal configuration of computer system 630.

Referring to FIG. 16, computer system 630 includes a computer 640 having a memory port 652 and a DVD (Digital Versatile Disk) drive 650, and a keyboard 646, a mouse 648, and a monitor 642 all connected to computer 640.

Referring to FIG. 17, computer 640 includes, in addition to memory port 652 and DVD drive 650, a CPU (Central Processing Unit) 656, a bus 666 connected to CPU 656, memory port 652 and DVD drive 650, a read only memory (ROM) 658 storing a boot-up program and the like, a random access memory (RAM) 660 connected to bus 666, storing program instructions, a system program and work data, and a hard disk 654. Computer system 630 further includes a network interface (IF) 644 providing the connection to a network 668 allowing communication with another terminal.

The computer program causing computer system 630 to function as each of the functioning sections of the anaphora/ellipsis resolution systems in accordance with the embodiments above is stored in a DVD 662 or a removable memory 664 loaded to DVD drive 650 or to memory port 652, and transferred to hard disk 654. Alternatively, the program may be transmitted to computer 640 through network 668, and stored in hard disk 654. At the time of execution, the program is loaded to RAM 660. The program may be directly loaded from DVD 662, removable memory 664 or through network 668 to RAM 660.

The program includes a plurality of instructions to cause computer 640 to operate as functioning sections of the anaphora/ellipsis resolution systems in accordance with the embodiments above. Some of the basic functions necessary to cause computer 640 to realize each of these functioning sections are provided by the operating system running on computer 640, by a third party program, or by various programming tool kits or dynamically linkable program library, installed in computer 640. Therefore, the program may not necessarily include all of the functions necessary to realize the system and method of the present embodiment. The program has only to include instructions to realize the functions of the above-described system by dynamically calling appropriate functions or appropriate program tools in a program tool kit or program library in a manner controlled to attain desired results. Naturally, all the necessary functions may be provided by the program only.

[Possible Modifications]

The embodiments above are directed to the anaphora/ellipsis resolution process for Japanese. The present invention, however, is not limited to such embodiments. The concept of using word sequences of the whole sentence and to form word vector groups from a plurality of viewpoints is applicable to any language. Therefore, the present invention is believed to be applicable to other languages (such as Chinese, Korean, Italian and Spanish) in which referring expressions and anaphora appear frequently.

Further, in the embodiments above, as word vector sequences using the word sequences of the whole sentence, four different types are used. The word vector sequences, however, are not limited to these four types. Any vector sequence that is formed by using word sequences of the whole sentence from different viewpoints may be used. Further, if at least two types of such vector sequences that use word sequences of the whole sentence are used, a word vector sequence using word sequences of a part of the sentence may be additionally used. Further, not only a simple word sequence but also a word sequence including part of speech information thereof may be used.

The embodiments as have been described here are mere examples and should not be interpreted as restrictive. The scope of the present invention is determined by each of the claims with appropriate consideration of the written description of the embodiments and embraces modifications within the meaning of, and equivalent to, the languages in the claims.

### INDUSTRIAL APPLICABILITY

The present invention is generally applicable to devices and services that require interaction with humans, and further, it is usable for devices and services for improving interface with humans in various devices and services by analyzing human speeches.

### REFERENCE SIGNS LIST

90 sentence
100, 102, 104 predicates
106 zero-pronoun
110, 112, 114, 116 words
160 anaphora/ellipsis resolution system
170 input sentence
174 output sentence
200 morphological analysis unit
202 dependency relation analysis unit
204 analyzed sentence
206 Base word sequence extracting unit
208 SurfSeq word sequence extracting unit
210 DepTree word sequence extracting unit
212 PredContext word sequence extracting unit
214 MCNN
216 anaphora/ellipsis analysis unit
230 analysis control unit
232 score calculating unit
234 list storage unit
236 identification unit
238 word vector converting unit
250 antecedent candidate
260, 262, 264, 300, 302 word sequence
280, 282 partial tree
284 dependency path
340 neural network layer
342, 542 concatenating layer
344, 544 Softmax layer
360 first convolutional neural network group
362 second convolutional neural network group
364 third convolutional neural network group
366 fourth convolutional neural network group
390 convolutional neural network
400 input layer
402 convolutional layer
404 a pooling layer
530 MCLSTM (Multi Column LSTM)
540 LSTM layer
550 first LSTM group
552 second LSTM group
554 third LSTM group
556 fourth LSTM group
600, 602, 604 vector sequences

1. A context analysis apparatus for identifying, in a context of sentences containing a first word, a second word having a prescribed relation with the first word, wherein the relation of the second word with the first word is not clearly recognizable only from the sentences, the apparatus comprising:
an analysis object detecting means for detecting the first word as an object of analysis in the sentences;
a candidate searching means for searching the sentences for word candidates that have a possibility of being the second word having a certain relation with the object of analysis, for the object of analysis detected by the analysis object detecting means; and
a word determining means for determining a one word candidate from the word candidates searched out by the candidate searching means as the second word, for the object of analysis detected by the analysis object detecting means; wherein
the word determining means includes
a word vector group generating means for generating a group of different types of word vectors determined by the sentences, the object of analysis and the word candidate, for each of the word candidates,
a score calculating means pretrained by machine learning for outputting, for each of the word candidates, a score indicating a possibility that the word candidate is related to the object of analysis, using the group of word vectors generated by the word vector group generating means as inputs, and
a word identifying means for identifying a word candidate having the best score output from the score calculating means as the word having a certain relation with the object of analysis; and wherein
the group of different types of word vectors each includes one or a plurality of word vectors generated by using at least a word sequence of the entire sentences excluding the object of analysis and the word candidate.

2. The context analysis apparatus according to claim 1, wherein
the score calculating means is a neural network having a plurality of sub-networks; and
the one or a plurality of word vectors is each input to the plurality of sub-networks included in the neural network.

3. The context analysis apparatus according to claim 2, wherein each of the plurality of sub-networks is a convolutional neural network.

4. The context analysis apparatus according to claim 2, wherein each of the plurality of sub-networks is an LSTM

5. The context analysis apparatus according to claim 1, wherein
the word vector group generating means includes any combination of
a first generating means for generating a word vector sequence representing a word sequence included in the entire sentences,
a second generating means for generating word vector sequences respectively from a plurality of word sequences divided by the first word and the word candidates in the sentences,
a third generating means for generating and outputting, based on a dependency tree obtained by parsing the sentences, arbitrary combinations of word vector sequences obtained from word sequences obtained from a partial tree related to the word candidates, word sequences obtained from a dependent partial tree of the first word, word sequences obtained from a dependency path of the dependency tree between the word candidates and the first word, and word sequences obtained from each of the remaining partial trees of the dependency tree, and
a fourth generating means for generating and outputting two word vector sequences representing word sequences obtained respectively from word sequences preceding and succeeding the first word in the sentences.

6. A non-transitory computer readable medium having stored thereon a computer program causing a computer to function as the context analysis apparatus according to claim 1.
